(19) United States
(12) Patent Application Publication
(10) Pub. No.: US 2007/0079024 A1
(43) Pub. Date: Apr. 5, 2007

(54) Circuit and method for detecting non-volatile memory during a boot sequence

(75) Inventor: Paul M. Wayner, Fairfax, VA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR, Inc.

(21) Appl. No.: 11/239,040

(22) Filed: Sep. 30, 2005

(51) Int. Cl. G06F 5/00

(52) U.S. Cl. 710/52

(57) ABSTRACT

A circuit (500) and method (600, 700) are presented for detecting non-volatile memory (NVM) devices (321, 323, 325) associated with computing device during a processor boot sequence. The NVM devices have corresponding starting addresses (331, 332, 333)and the processor begins operation from a first starting address associated with a first NVM devices after a reset interval. The circuit includes NVM device detectors which determine whether the NVM devices are present by reading (512, 514, 516) an authentication code including an identifier, a codeword, a NVM size, or a NVM type from a predetermined location within the each of the NVM devices if present. If the NVM device is not present, the detector returns an instruction (513, 515, 517) for the processor to continue execution at a starting addresses for a next NVM device.

### FIELD OF THE INVENTION

The present invention relates generally to computer boot sequence processing. In particular, the present invention relates to an circuit and method in a device such as a computing device, including a receiver located in mobile transceivers, centralized transceivers, related equipment, including Ultra Wideband (UWB) devices for detecting non-volatile memory (NVM) devices during a boot sequence.

### BACKGROUND OF THE INVENTION

Processing circuits in modern electronic computing devices including radio transmitters and receivers face unique challenges in conducing boot operations due in part to high speed requirements and requirements involving modularity, scalability, simplicity, robustness of operation, and the like. In particular, given that, for reasons understood in the art, modularity and scalability requirements are important to allow for a standard computing platform to be configured differently for different levels of operation, additional operating features or feature packages can be provided based on the provisioning of the standard computing platform with different software that can be read from, for example, NVM devices integrated with the computing platform or inserted into the device during manufacture, or even inserted into the computing platform by a user after purchase or the like.

The use of different NVM devices while providing a rich variety of features for the used can pose problems in that, depending on the number and size of the NVM devices, the computing platform may have difficulty accessing the NVM devices. The computing platform must be equipped with a complicated memory controller to manage the various memory devices. Alternatively, the computing platform must restrict the use NVM devices to use of devices of a standard size at a standard address. Neither option is ideal when flexibility and scalability are the primary goal.

For example, in the case of a memory manager, logical or virtual addresses are mapped to the physical memory space such that when a processor reads from a logical or virtual address, the memory controller resolves the logical or virtual address and accesses the physical memory associated with the logical or virtual address. In order to perform the mapping the memory controller must obtain the memory configuration from a Basic Input Output System (BIOS) setting or must conduct a check of the physical memory space adding to the overall time required to conduct the boot sequence. Still further, as noted, each memory access is conducted as a translation and thus takes additional time per access leading to potential speed issues for devices with high speed operational requirements.

Thus it would be advantageous for a computing platform having the capability to boot in a consistent manner while having the ability to read from any NVM devices which may be present without the need for length address translation schemes, complicated memory manager devices, and the like.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a diagram illustrating portions of an basic hardware configuration in accordance with various exemplary embodiments of the present invention;

FIG. 2 is a diagram illustrating a conventional processor boot sequence from a read only memory (ROM);

FIG. 3 is a diagram illustrating an exemplary device including a processor and NVM detector circuits in accordance with various exemplary embodiments of the present invention;

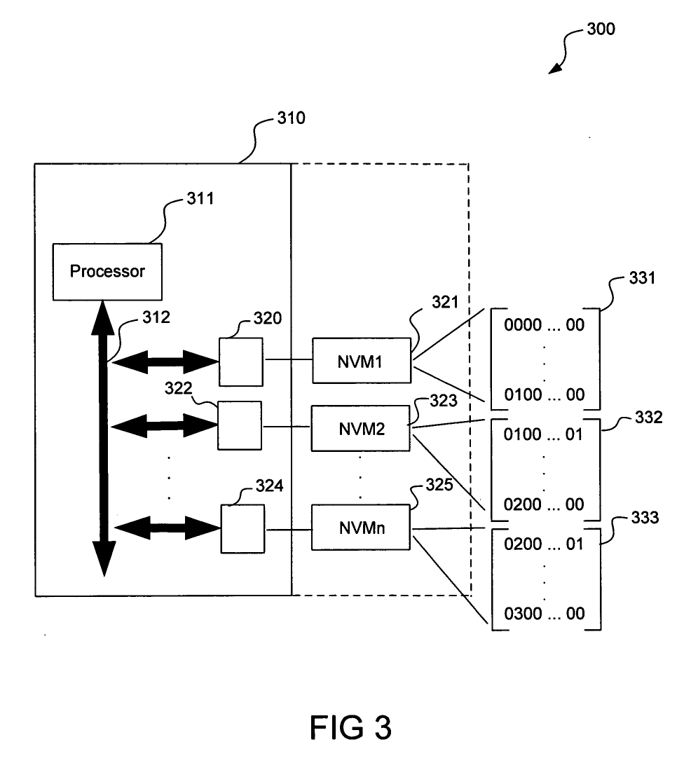

FIG. 4 is a diagram illustrating exemplary processing flows for determining the presence of NVM devices in accordance with exemplary embodiments of the present invention;

FIG. 5 is a diagram of an exemplary circuit, including a processor and NVM detector circuits, in accordance with various exemplary embodiments of the present invention;

FIG. 6 is a flow chart illustrating an exemplary procedure in accordance with various exemplary embodiments of the present invention; and

FIG. 7 is a flow chart illustrating an exemplary procedure in accordance with various alternative exemplary embodiments of the present invention.

### DETAILED DESCRIPTION OF PREFERRED EMBODIMENTS

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as an embedded processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

Accordingly, in one embodiment, a method is described for detecting the presence of two or more or more non-volatile memory (NVM) devices during an execution sequence, such as a boot sequence or the like, associated with a processor. It will be understood that the two or more NVM devices have a corresponding two or more predetermined starting addresses. The processor can be reset to begin operation from a first one of the starting addresses associated with a first one of the NVM devices when the reset operation is completed. Meanwhile, it can be determined whether each of the NVM devices is present. Reading can be conducted from the first of the predetermined starting addresses associated with the first NVM device. If the first NVM device is determined to be not present, the processor is instructed, such as through a JUMP instruction, to continue execution at a second starting address associated with a second one of the NVM devices. Determining can occur during the resetting and prior to the processor beginning operation, for example by holding the processor in a reset condition until the determining is completed for each of the NVM devices.

Alternatively, reading from the starting addresses can begin and the processor can be caused to wait if the determining for one or more of the NVM devices has not completed. After the processor begins operation, reading can be conducted from any address associated with the first NVM device and, if not present, the processor can be instructed, such as with a JUMP instruction, to continue execution at the second one of the two or more starting addresses associated with the second one of the two or more NVM devices. Determining can includes reading, independently from the processor, such as using an NVM detector circuit described in greater detail hereinafter, an authentication code from a known location within the each of the two or more NVM devices. The authentication code can include an identifier, a codeword, a NVM size, a NVM type, or the like, or a combination thereof. Reading can further be conducted from the second predetermined starting address associated with the second NVM device and, if the second is not present, the processor can be instructed, such as with a JUMP instruction, to continue execution at a third one of the two or more starting addresses associated with a third one of the two or more NVM devices to the processor. It will be appreciated that the same procedure can be used on any number of NVM devices. Accordingly, after the processor begins operation, reading from any address associated with the second NVM device if not present, will cause the processor to be instructed, such as with a JUMP instruction, to continue execution at the third starting addresses associated with a third NVM devices and so on.

In accordance with another exemplary embodiment, a circuit is disclosed for detecting the presence of two or more non-volatile memory (NVM) devices during a processor boot sequence. The NVM devices have corresponding predetermined starting addresses. The circuit includes a processor configured to begin operation from a first predetermined starting address associated with a first NVM devices after a reset interval. The circuit further can includes a bus coupled to the processor and two or more detector circuits coupled to the bus. The detector circuits are capable of coupling to the NVM devices and are configured to determine whether a respective one of the NVM devices associated with a respective predetermined starting address is present. The processor can read from the first predetermined starting address associated with the first NVM device, and jump to a second starting address associated with a second NVM device if the first NVM device is determined by a respective first detector circuit to be not present. The processor can further jump to a next one of the starting addresses upon a read by the processor in an address range associated with the respective NVM device if the device is not present. It will be appreciated that in accordance with the present embodiment, the circuit can be constructed as an integrated circuit and at least one of the NVM devices, if present, is integrated into the integrated circuit and coupled to a respective one of the detector circuits. Alternatively, at least one of the NVM devices, if present, is an external NVM device electrically connected to a respective one of the detector circuits.

In accordance with still another exemplary embodiment, a circuit is disclosed for detecting the presence of two or more non-volatile memory (NVM) devices during a processor boot sequence. The two or more NVM devices have corresponding predetermined starting addresses. The processor associated with the processor boot sequence can be configured to begin operation from a first one of the predetermined starting addresses associated with a first one of the NVM devices after a reset interval. The exemplary circuit includes a first NVM device detector circuit configured to determine whether the first NVM device associated with the first predetermined starting address is present. If the first NVM device is not present, the first detector circuit can return an instruction, such as a JUMP instruction, for the processor to continue execution at a second one of the predetermined starting addresses upon a read by the processor at the first predetermined starting address. The circuit further includes a second NVM device detector circuit configured to determine whether the second one of the NVM devices associated with the second predetermined starting addresses is present. If the second NVM device is not present, the second detector circuit can return an instruction, such as a JUMP instruction, for the processor to continue execution at a next one of the predetermined starting addresses upon a read by the processor at the second predetermined starting address.

It should be noted that the first NVM device detector circuit and the second NVM device detector circuit can be configured to hold the processor in a reset state, such as prolonging the reset interval, until the determination of whether the first NVM device and the second NVM device are present is completed. Alternatively, the first NVM device detector circuit and the second NVM device detector circuit can cause the processor to wait if the determination of whether the first NVM device and the second NVM device are present is not complete upon the read from the processor. The first NVM device detector circuit and the second NVM device detector circuit can make the determination of whether the respective NVM devices are present by reading an authentication code from a predetermined location within the each of the NVM devices if they are present. If the NVM devices are not present, or if the NVM devices are inoperable or have failed, the authentication code read will fail and the device will be deemed as not present. It will be appreciated that the authentication code can include an identifier, a codeword, a NVM size, and a NVM type. It will be appreciated that in accordance with the present embodiment, the circuit can be constructed as an integrated circuit where at least one of the NVM devices, if present, is integrated into the integrated circuit and is coupled to a respective one of the NVM device detector circuits. Alternatively, at least one of the NVM devices, if present, is an external NVM device electrically connected to a respective one of the NVM device detector circuits.

Processor Boot Sequence

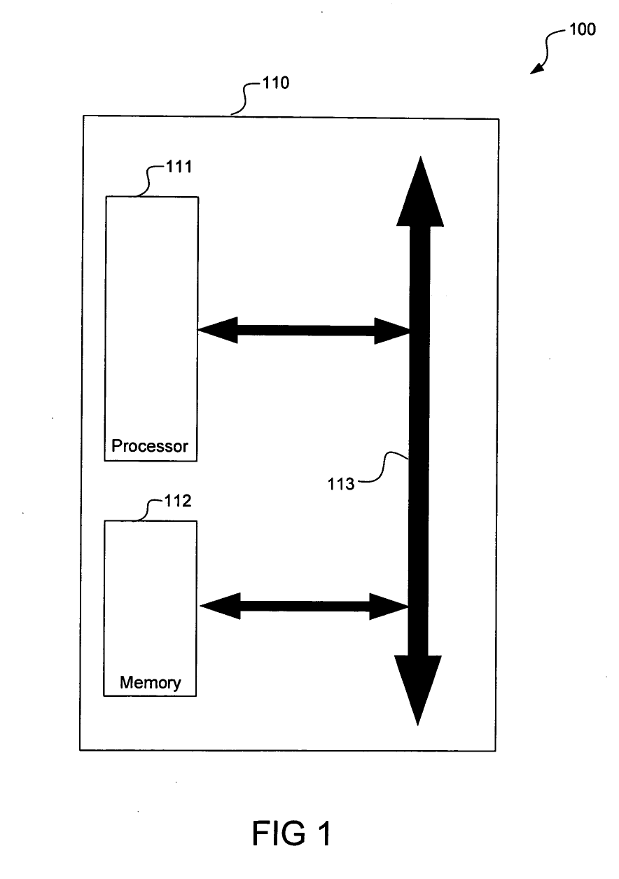

A typical computing device configuration 100, for example, as shown in FIG. 1, can include a processor module 110 such as a processing circuit or the like. It will be appreciated that such a basic circuit can be found in many types of devices and generally can be integrated or can be made up of discrete devices on a circuit board. The processor module 110 can be found in many devices including communication devices such as radio communication devices and radio communication devices for use within the band known as the Ultra Wideband (UWB). UWB is commonly defined as any radio communication device operating in a spectrum that occupies a bandwidth greater than 20 percent of the center frequency, or a bandwidth of at least 500 MHz. Accordingly, the processor module 110 can include a processor 111, a memory 112 and a bus 113. Such a basic configuration is well known to those of skill in the art. The processor can be a general purpose processor, a high speed processor, an application specific integrated circuit (ASIC), a digital signal processor, a programmable array, or the like. The processor 111 can communicate with the memory 112 over the bus 113 in order to retrieve and store information therein. It will be appreciated that in some configurations, the processor module 110 can constitute the processor, with the memory 112 and the bus 113, or other interconnection being integrated together and packaged into the same circuit or device.

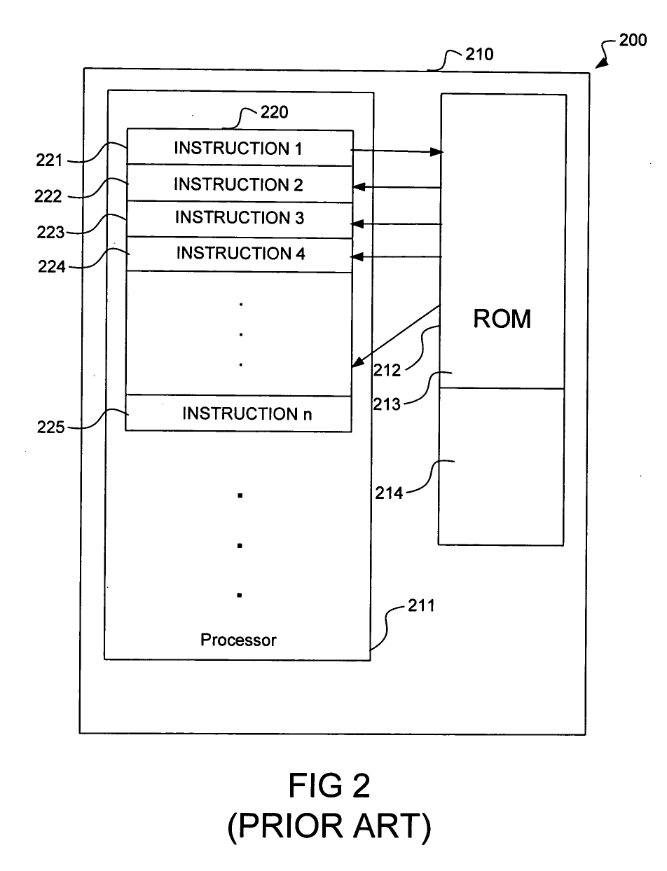

In accordance with various known boot procedures, a conventional device configuration 200, shown in FIG. 2, can include a processor module 210 having a processor 211, and a memory 212. While not shown for the sake of simplicity, the processor 211 and the memory 212 can be connected by a bus as shown for example, in FIG. 1. Alternatively, if the processor 211 and the memory 212 are integrated together they may be directly connected in a manner known to those of ordinary skill in the art. The memory 212 can be a non-volatile memory (NVM) device such as a read-only-memory (ROM), a programmable ROM, or the like. The ROM can include segments or partitions such as segment 213 and 214. The segments can contain different information such as boot information in the form of instructions associated with a boot sequence which can be read by the processor 211 and executed. The segments can also contain other programmed values such as constants or the like as would be appreciated by one of ordinary skill in the art.

During a typical boot sequence, the processor 211 will begin operation at the end of a reset interval such as at the end of a power-up reset interval or system reset interval which can occur during power-up, during a recovery from a low power scenario such as a black out or a brown out or other power interruptions, by pressing a reset button or in other ways such as through software. The processor 211 can be configured with an instruction unit or instruction register 220. Data loaded thereinto will be processed as an instruction. As will be appreciated, when the processor 211 comes out of the reset state, it typically will begin execution by, for example, reading from a default address within the memory 212 associated for example with an instruction 1 221 in the instruction register 220. The processor 211 reads from the memory 212 to load and execute an instruction 2 222, an instruction 3 223, an instruction 4 224 and so on until the end of the boot sequence at an instruction n 225 is reached. The contents of the memory 212, since presumable part of the boot sequence of the processor, will contain instructions associated with, for example, loading the BIOS or the like to begin addition operations such as loading the operating system or the like, and finally to execute applications. It will be appreciated that other routines can be run as part of the boot sequence such as a Power-On Self Test (POST), which checks that devices attached to the processor 211 are functioning; and also initializes these devices. Additionally, the BIOS looks through list of devices until it finds a device from which it can load the operating system kernel. In addition to containing the boot sequence as described, the memory 212 can also contain additional instructions 214 such as a secondary boot loader, a BIOS or the like as will be appreciated.

Difficulties can arise in computing devices where the boot sequence depends on the provisioning of the exemplary computing device or processor module with a variety of non-volatile memory (NVM) devices. Such difficulties are described hereinabove and include the need for a complicated memory controller if two or more NVM devices are used. It will be appreciated that use of multiple NVM devices may be necessary, for example, where a single computing device includes devices or modules made by different manufacturing units within a company or made by third parties which require specific boot sequences to be executed. Such use of multiple NVM devices is advantageous in that each manufacturing unit or third party can provide an NVM device corresponding to its module or the like. Alternatively, different feature packages or portions thereof can be provisioned into a computing device by the installation of a particular series of NVM devices.

Therefore, in accordance with the present invention, an exemplary computing device configuration 300 can include a processor module 310 which is coupled to a bus 312 and to NVM device detectors 320, 322, and 324. The NVM device detectors 320, 322, and 324 are capable of being coupled to an NVM1 device 321, an NVM2 device 323, and an NVM3 device 325 which may or may not be present. The NVM devices 321, 323, and 325 can be internal or external memory devices, or a combination thereof, and, if internal, can be integrated with the processor module 310 as an integrated circuit. Each of the NVM devices 321, 323, and 325 can be associated with, for example, a respective fixed physical address space 331, 332 and 333. The physical address spaces 331, 332 and 333 each have a starting address, for example 0000 . . . 00 for the NVM1 device 321, 0100 . . . 01 for the NVM2 device 323, and 0200 . . . 01 for the NVMn device 325. It will be appreciated that the values used herein to describe the starting addresses are representative only and are used for simplicity and illustrative purposes. In an actual implementation the addresses could be described in hexadecimal or the like as would be understood by one of ordinary skill. It will also be appreciated that while two numbered devices are shown, such as the NVM1 device 321 and the NVM2 device 323, multiple NVM devices such as up to the NVMn device 325 can be used in accordance with the present invention.

After reset is completed, the processor such as the processor 311 can begin execution from a first starting address such as from a base memory address. It will be important to locate the first NVM device, or at least the first NVM device detector at the first address. Accordingly, a first detection operation 420 which can be performed, for example, in the first NVM device detector 320 will read at 421 from a predetermined address within the NVM1 device 321 by performing a read operation 422, which can include reading from an absolute address within the NVM1 device 321, reading from the starting address of the NVM1 device 321, or reading from the starting address of the NVM1 device 321 plus an offset to find an authentication code such as an identifier or a codeword. If the authentication code returned at 424 from the read operation is validated, the detection operation 420 can consider that the NVM1 device 321 is present. If the authentication code returned at 424 is not validated, for example as shown in the figure, then the detection operation 420 can consider that the NVM1 device 321 is not present at 423 or has malfunctioned in some way and is unreadable. Likewise, a second detection operation 430 which can be performed, for example, in the second NVM device detector 322 will read at 431 from a predetermined address within the NVM2 device 323 by performing a read operation 432, which can include reading from an absolute address within the NVM2 device 323, reading from the starting address of the NVM2 device 323, or reading from the starting address of the NVM2 device 323 plus an offset to find an authentication code such as an identifier or a codeword. If the authentication code returned at 434 from the read operation is validated at 433, the detection operation 430 can consider that the NVM2 device 323 is present. If the exemplary computing device is configured for additional NVMs, a third detection operation 440 which can be performed, for example, in the n^{th} NVM device detector 325 will read at 441 from a predetermined address within the NVMn device 325 by performing a read operation 442, which can include reading from an absolute address within the NVMn device 325, reading from the starting address of the NVMn device 325, or reading from the starting address of the NVMn device 325 plus an offset to find an authentication code such as an identifier or a codeword. If the authentication code returned at 444 from the read operation is validated at 443, the detection operation 440 can consider that the NVMn device 325 is present. It will be appreciated that the exemplary codeword can further include the size and type of the NVM device so as to allow the processor 310 greater flexibility in utilizing the device during operation where necessary or appropriate.

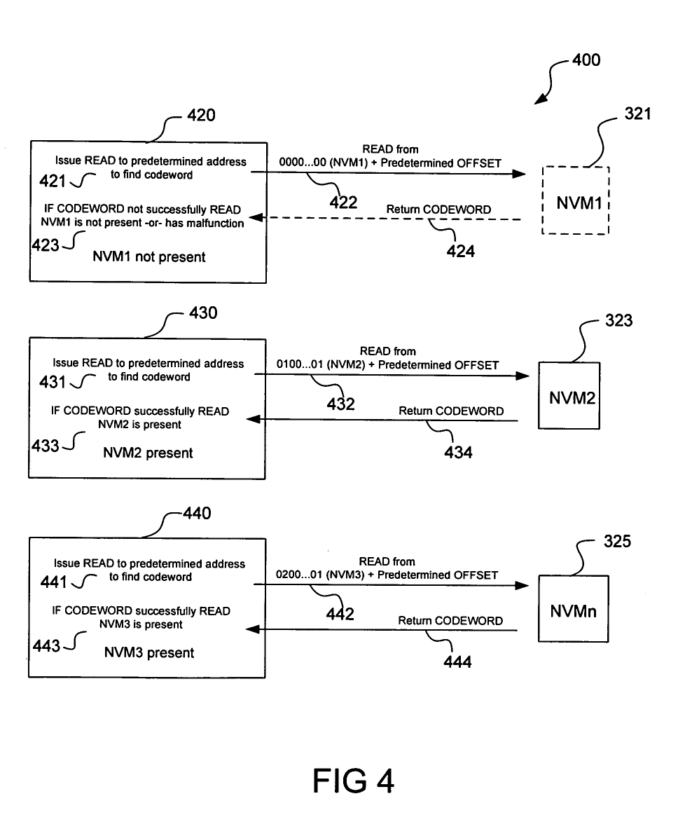

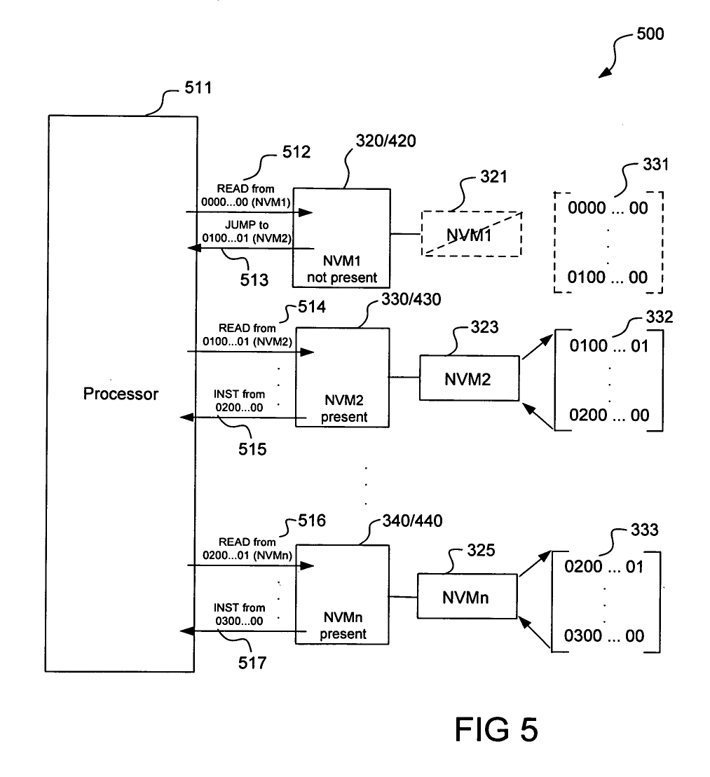

Once it has been determined that the NVM devices are present, or while a determination is being made as to whether the NVM devices are present, a read to the devices will either be successfully made, or will result in a redirection as shown in an exemplary configuration 500 in FIG. 5 having a processor 511. As in the previous description, for example in connection with FIG. 4, the NVM1 device 321 will be assumed to be not present. Further, the determination of whether the devices such as the NVM1 device 321, the NVM2 device 332, the NVMn device 325 are present can be made during the reset of the processor 511 or can be made after the reset and during the boot sequence. For example, if it is desired that the determination be made during the reset of processor 511, reset can be prolonged in a manner known in the art, such as by each of the detectors holding the reset line down until the determination by each of the detectors is complete. Such logic is relatively simple and well known and therefore is not shown for the sake of simplicity. Alternatively, the detectors can conduct detection operations after reset and after the processor 511 begins to attempt to read from the NVM devices. If the processor 511 reads from the NVM devices while detection is still underway, the corresponding detector can simply cause the processor 511 to wait until the detection operation is complete whereupon the detector will either return a jump instruction or will allow the processor 511 to read from the NVM with no interference. Accordingly, when the processor 511 performs a read at 512 from the device detector 320 conducting, for example, the detection operation 420, the NVM1 device 321 will have been determined to be not present and the device detector 320 will return a JUMP instruction at 513 to the processor 511 causing the processor 511 to read from the starting address of the NVM2 device 332. Since the device detector 330 conducting, for example, the detection operation 430 has determined that the NVM2 device 323 is present, the processor 511 will be able to read at 514 unimpeded from the contents of NVM2 device 332 including from the starting address 0100 . . . 01 332 to the end address 0200 . . . 00. When the contents such as an instruction are returned to processor 511 at 515, the processor 511 will continue to the starting address of the next device. Since the device detector 340 conducting, for example, the detection operation 440 has determined that the NVMn device 325 is present, the processor 511 will begin to read instructions from the starting address of the NVMn device 325 at 0200 . . . 01 at 516 and continue to read through the contents of the NVMn device 325 to the end address at 0300 . . . 00. It will be appreciated that in accordance with various exemplary embodiments, the NVM devices can contain, as a final instruction, a jump to the starting address of the next device or, as in the case where the size of the device is given during detection and authentication, the size of the device will be known and therefore when the end of the NVM device is reached the processor will be configured to begin the next read from the starting address of the next device particularly where the memory boundaries are not contiguous due to the use of a small sized device or the like.

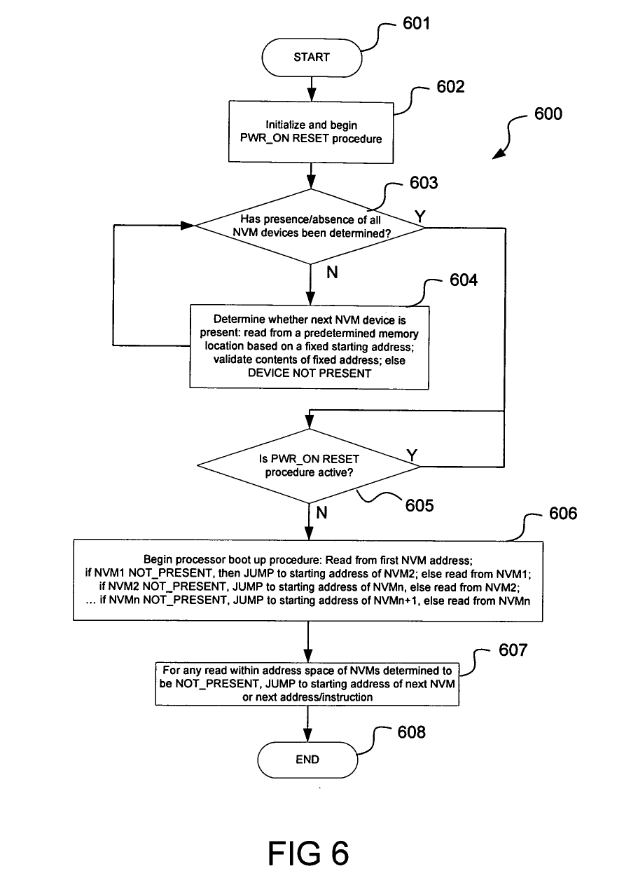

An exemplary procedure 600 in accordance with the present invention is shown in FIG. 6. It will be appreciated that the exemplary procedure 600 can be practiced on exemplary devices as discussed and described herein or on other devices without departing from the invention. After start at 601, an exemplary computing device can initialize and begin, for example, a power on reset procedure such as a system wide hardware reset which will reset the processor, such as the processor 511, and cause the processor to begin operation from a predefined starting address such as the starting address of the first NVM device at 602. In one exemplary embodiment, the reset procedure can be extended until the presence or absence of all NVM devices has been determined. Thus a test can be made at 603 as to whether the presence or absence of all the devices has been determined. If not, at 604 the exemplary procedure can determine whether a next device, including the first device when no previous devices have been checked, by reading from a predetermined fixed location within the NVM device based, for example, on a fixed starting address. The contents of the fixed address such as a codeword or the like can be authenticated or validated as described hereinabove or if not validated then it is determined that the device is not present. The exemplary procedure can loop between 603 and 604 while there are NVM devices the presence or absence of which has not been determined.

When the presence or absence of all the NVM devices has been determined, the processor can be released from reset by the detectors. A test can be made at 605 to determine whether the processor is still held in reset, for example by another device. If no other devices within the computing device are holding the processor in reset, the processor boot up procedure can begin at 606 by reading from the first NVM address. If the first NVM device, such as the NVM1 device 321 is not present, then the processor can jump to the starting address of the second NVM device such as the NVM2 device 323, otherwise the processor can read through the contents of the first NVM device. If the second NVM device is not present, then the processor can JUMP to the starting address of the next NVM device such as the NVMn device 325, otherwise the processor can read through the contents of the second NVM device. If the NVMn device 325 is not present, then the processor can jump to the starting address of NVMn+1, otherwise the processor can read through the contents of the n^{th} NVM device. Thereafter, for example, at 607 if a read is made to any NVM device determined to be not present, the processor can jump to a starting address or a next address or instruction. While the exemplary procedure is indicated as ending at 608, it will be appreciated that additional processing may be conducted such as the loading of the operating system or the like as described hereinabove. Further, if the computing device is manually reset, reset through software, powered down, or the like, the exemplary procedure can be repeated as described hereinabove.

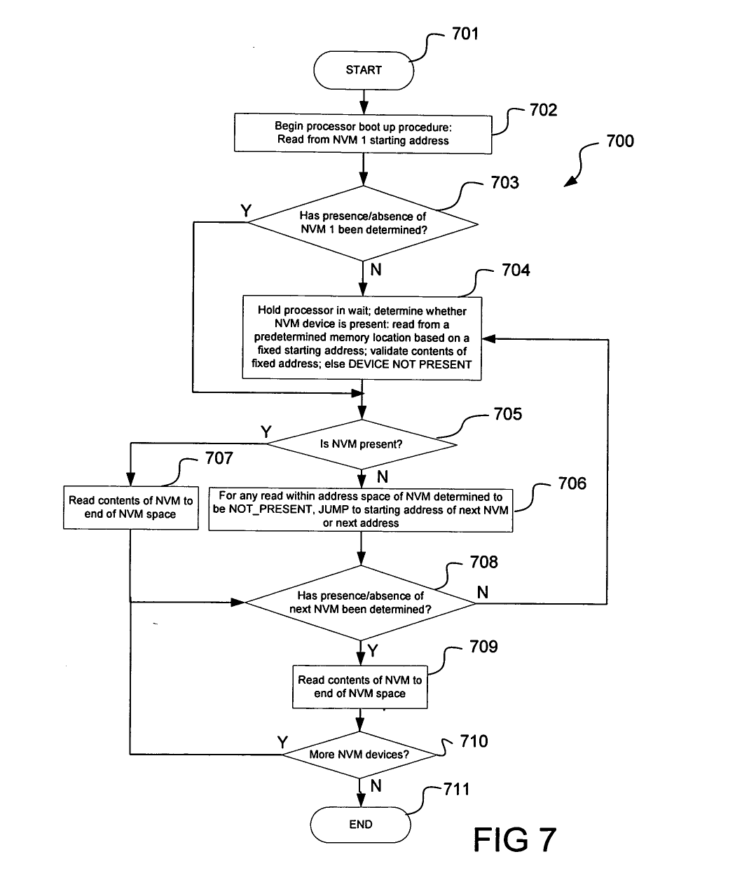

In accordance with other exemplary embodiments, another exemplary procedure 700 can be conducted in accordance with the present invention as shown in FIG. 7. After start at 701, which in the present embodiment can include the time after the reset of the processor is complete, the processor can begin operation such as a boot up procedure by reading from the starting address of the first NVM device, such as the NVM 1 device 321, at 702. A test can be made at 703 as to whether the presence or absence of the first NVM device has been determined. If not, the processor can be held in a wait state until a read from a fixed address is conducted as described above. The contents of the read will be validated to determine whether the device is present for example by reading and validating an identifier, codeword or the like. If the presence or absence of the NVM device has been determined at 703 or if the determination is complete at 704, a second test can be made at 705 as to whether the NVM device is present. If so, the contents of the NVM can be read at 707. If not, then any read within the address space of the NVM device will result in a JUMP instruction being returned to the processor to continue execution at the starting address of the next NVM device at 706. At 708, a test can be made as to whether the presence or absence of the next NVM device has been made. If so, the contents of the next NVM device can be read at 709. If the presence or absence of the next NVM device has not been determined, the exemplary procedure can loop back to 704 where the processor can be held in a wait state until a read from a fixed address associated with the next NVM is conducted as described above. The contents of the read will be validated to determine whether the device is present for example by reading and validating an identifier, codeword or the like. A test can be performed at 710 to determine whether more NVM devices are present although in practical applications the exemplary procedure is designed to pass through in a fashion which is largely transparent to the processor. In other words, as long as there are devices to read from, each device will either be read through and the processor will continue reading from the starting address of the next NVM device, or if devices are not present, the processor will jump to the starting address of the next device. If there are no more NVM devices present, the exemplary procedure can end at 712. It will be appreciated that by ending, the exemplary procedure will pass control to a secondary boot loader or other program which should begin operations such as loading the operating system or the like once the end of the address space associated with the last device in the series of NVM devices has been reached.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method for detecting the presence of two or more or more non-volatile memory (NVM) devices during an execution sequence associated with a processor, the two or more NVM devices having a corresponding two or more predetermined starting addresses, the method comprising:
resetting the processor to begin operation from a first one of the two or more predetermined starting addresses associated with a first one of the two or more NVM devices when the reset operation is completed;
determining whether each of the two or more of NVM devices including the first one of the two or more NVM devices associated with the first one of the two or more predetermined starting addresses is present; and
reading from the first one of the two or more predetermined starting addresses associated with the first one of the two or more NVM devices and, if the first one of the two or more NVM devices is determined, in the determining, to be not present, instructing the processor to continue execution at a second one of the two or more starting addresses associated with a second one of the two or more NVM devices.

2. A method as recited in 1, wherein the determining further includes determining, during the resetting and prior to the processor beginning operation, whether each of the two or more of NVM devices is present.

3. A method as recited in 1, wherein the resetting includes holding the processor in a reset condition until the determining is completed for each of the two or more NVM devices.

4. A method as recited in 1, further comprising reading, after the processor beginning operation, from any address associated with the first one of the two or more NVM devices and, if the first one of the two or more NVM devices is determined, in the determining, to be not present, instructing the processor to continue execution at the second one of the two or more starting addresses associated with the second one of the two or more NVM devices.

5. A method as recited in claim 1, wherein the determining further includes reading, independently from the processor, an authentication code from a known location within the each of the two or more NVM devices.

6. A method as recited in claim 5, wherein the authentication code includes one or more of: an identifier, a codeword, a NVM size, and a NVM type.

7. A method as recited in 1, further comprising reading from the second one of the two or more predetermined starting addresses associated with the second one of the two or more NVM devices and, if the second one of the two or more NVM devices is determined in the determining not to be present, instructing the processor to continue execution at a third one of the two or more starting addresses associated with a third one of the two or more NVM devices to the processor.

8. A method as recited in 7, further comprising reading, after the processor beginning operation, from any address associated with the second one of the two or more NVM devices and, if the second one of the two or more NVM devices is determined, in the determining, to be not present, instructing the processor to continue execution at a third one of the two or more starting addresses associated with a third one of the two or more NVM devices.

9. A circuit for detecting the presence of two or more non-volatile memory (NVM) devices during a processor boot sequence, the two or more NVM devices having a corresponding two or more predetermined starting addresses, the circuit comprising:
a processor configured to begin operation from a first one of the two or more predetermined starting addresses associated with a first one of the two or more NVM devices after a reset interval;
a bus coupled to the processor; and
two or more detector circuits coupled to the bus, and capable of coupling to the two or more NVM devices, each of the two or more detector circuits configured to determine whether a respective one of the two or more NVM devices associated with a respective one of the two or more predetermined starting addresses is present.

10. A circuit as recited in claim 9, wherein the processor is further configured to:
read from the first one of the two or more predetermined starting addresses associated with the first one of the two or more NVM devices, and
jump to a second one of the two or more starting addresses associated with a second one of the two or more NVM devices if the first one of the two or more NVM devices is determined by a respective first one of the two or more detector circuits to be not present.

11. A circuit as recited in claim 9, wherein the processor is further configured to jump to a next one of the two or more starting addresses upon a read by the processor in an address range associated with the respective one of the two or more NVM devices if the respective one is not present.

12. A circuit as recited in claim 9, wherein the circuit includes an integrated circuit and wherein at least one of the two or more NVM devices, if present, is integrated into the integrated circuit and coupled to a respective one of the two or more detector circuits.

13. A circuit as recited in claim 9, wherein the circuit includes an integrated circuit and wherein at least one of the two or more NVM devices, if present, is an external NVM device electrically connected to a respective one of the two or more detector circuits.

14. A circuit for detecting the presence of two or more non-volatile memory (NVM) devices during a processor boot sequence, the two or more NVM devices having a corresponding two or more predetermined starting addresses, the processor configured to begin operation from a first one of the two or more predetermined starting addresses associated with a first one of the two or more NVM devices after a reset interval, the circuit comprising:
a first NVM device detector circuit configured to:
determine whether the first one of the two or more NVM devices associated with the first one of the two or more predetermined starting addresses is present; and
return an instruction for the processor to continue execution at a second one of the two or more predetermined starting addresses upon a read by the processor at the first predetermined starting address if the first one of the two or more NVM devices is not present; and
a second NVM device detector circuit configured to:
determine whether the second one of the two or more NVM devices associated with the second one of the two or more predetermined starting addresses is present; and
return an instruction for the processor to continue execution at a next one of the two or more predetermined starting addresses upon a read by the processor at the second predetermined starting address if the second one of the two or more NVM devices is not present.

15. A circuit as recited in claim 14, wherein the first NVM device detector circuit and the second NVM device detector circuit are further configured to hold the processor in a reset state associated with the reset interval until the determining whether the first one of the two or more NVM devices and the second one of the two or more NVM devices are present is completed.

16. A circuit as recited in claim 14, wherein the first NVM device detector circuit and the second NVM device detector circuit are further configured to cause the processor to wait if the determining whether the first one of the two or more NVM devices and the second one of the two or more NVM devices are present is not complete upon the read.

17. A circuit as recited in claim 14, wherein the first NVM device detector circuit and the second NVM device detector circuit, in the determining are further configured to read an authentication code from a predetermined location within the each of the two or more NVM devices if present.

18. A circuit as recited in claim 14, wherein the authentication code includes one or more of: an identifier, a codeword, a NVM size, and a NVM type.

19. A circuit as recited in claim 14, wherein the circuit includes an integrated circuit and wherein at least one of the two or more NVM devices, if present, is integrated into the integrated circuit and coupled to a respective one of the first NVM device detector circuit and the second NVM device detector circuit.

20. A circuit as recited in claim 14, wherein the circuit includes an integrated circuit and wherein at least one of the two or more NVM devices, if present, is an external NVM device electrically connected to a respective one of the first NVM device detector circuit and the second NVM device detector circuit.
